(19) United States
(12) Patent Application Publication
(10) Pub. No.: US 2025/0139638 A1
(43) Pub. Date: May 1, 2025

(54) COMPUTER SYSTEM INTEGRATION FOR FACILITATING AUTOMATIC TRANSMISSION OF EVIDENCE BASED ON STANDARD REQUIREMENTS

(71) Applicant: Truist Bank, Charlotte, NC (US)

(72) Inventor: Cynthia Rhodes, Orlando, FL (US)

(73) Assignee: Truist Bank, Charlotte, NC (US)

(21) Appl. No.: 18/497,073

(22) Filed: Oct. 30, 2023

(51) Int. Cl. G06Q 30/018

(52) U.S. Cl. CPC G06Q 30/018

(57) ABSTRACT

A system can be provided for integrating evidence from multiple sources and providing the evidence to users for satisfying standards. For example, the system can store pieces of evidence in a repository. The system may then receive, from a user device, a request for evidence associated with a standard. In response to receiving the request, the system may access a mapping table that relates each of the pieces of evidence to one or more standards. The system can further identify, using the mapping table, one or more of the pieces of evidence that are related to the standard. Additionally, in response to identifying the one or more of the pieces of evidence that are related to the standard, the system can obtain the one or more of the pieces of evidence from the repository and can transmit the one or more of the pieces of evidence to the user device.

### TECHNICAL FIELD

The present disclosure relates generally to computer system integration and, more particularly (although not necessarily exclusively), to integrating multiple computer systems in a computing environment to facilitate automatic transmission of the evidence based on requirements of standards.

### BACKGROUND

Standards can represent regulatory requirements or guidelines imposed on an entity (e.g., a financial institution or a division within a financial institution) to provide stability, integrity, and accuracy in operations performed by the entity. Pieces of evidence (e.g., data records, log data, files, images, etc.) can demonstrate that the entity is meeting requirements (e.g., the regulatory requirements or guidelines) of the standard. The pieces of evidence can be managed by various computer systems associated with the entity. For example, the computer systems may include different nodes (e.g., physical or virtual servers), which each may store or manage different types of evidence. Additionally, the computer systems may include different software applications, software services, or the like. To satisfy standards, users may collect pieces of evidence based on each requirement of each standard. Users are often denied direct access to all or some of the evidence, and therefore may transmit requests, via user devices, to the computer systems that manage the evidence to obtain the evidence.

### SUMMARY

According to one example of the present disclosure, a system can include a processing device and a memory device including instructions that are executable by the processing device to perform operations. The operations can include storing a plurality of pieces of evidence in a repository. The operations can also include, subsequent to storing the plurality of pieces of evidence in the repository, receiving, from a user device, a request for evidence associated with a standard. Additionally, the operations can include, in response to receiving the request, accessing a mapping table that relates each piece of evidence of the plurality of pieces of evidence to one or more standards of a plurality of standards. The mapping table can relate each piece of evidence of the plurality of pieces of evidence to the one or more standards of the plurality of standards based on each piece of evidence satisfying a requirement of the one or more standards. The operations can further include identifying, using the mapping table, at least one piece of evidence of the plurality of pieces of evidence related to the standard. Then, in response to identifying the at least one piece of evidence of the plurality of pieces of evidence related to the standard, the operations can include obtaining the at least one piece of evidence from the repository and transmitting the at least one piece of evidence to the user device as a response to the request for the evidence associated with the standard.

According to another example of the present disclosure, a non-transitory computer-readable medium may contain instructions that are executable by a processing device to cause the processing device to perform operations. The operations can include storing a plurality of pieces of evidence in a repository. The operations can also include, subsequent to storing the plurality of pieces of evidence in the repository, receiving, from a user device, a request for evidence associated with a standard. Additionally, the operations can include, in response to receiving the request, accessing a mapping table that relates each piece of evidence of the plurality of pieces of evidence to one or more standards of a plurality of standards. The mapping table can relate each piece of evidence of the plurality of pieces of evidence to the one or more standards of the plurality of standards based on each piece of evidence satisfying a requirement of the one or more standards. The operations can further include identifying, using the mapping table, at least one piece of evidence of the plurality of pieces of evidence related to the standard. Then, in response to identifying the at least one piece of evidence of the plurality of pieces of evidence related to the standard, the operations can include obtaining the at least one piece of evidence from the repository and transmitting the at least one piece of evidence to the user device as a response to the request for the evidence associated with the standard.

According to a further example of the present disclosure, a computer-implemented method can include storing a plurality of pieces of evidence in a repository. The computer-implemented method can also include, subsequent to storing the plurality of pieces of evidence in the repository, receiving, from a user device, a request for evidence associated with a standard. Additionally, the computer-implemented method can include, in response to receiving the request, accessing a mapping table that relates each piece of evidence of the plurality of pieces of evidence to one or more standards of a plurality of standards. The mapping table can relate each piece of evidence of the plurality of pieces of evidence to the one or more standards of the plurality of standards based on each piece of evidence satisfying a requirement of the one or more standards. The computer-implemented method can further include identifying, using the mapping table, at least one piece of evidence of the plurality of pieces of evidence related to the standard. Then, in response to identifying the at least one piece of evidence of the plurality of pieces of evidence related to the standard, the computer-implemented method can include obtaining the at least one piece of evidence from the repository and transmitting the at least one piece of evidence to the user device as a response to the request for the evidence associated with the standard.

### BRIEF DESCRIPTION OF THE DRAWINGS

FIG. 1 shows a block diagram of an example of a computing environment for integrating evidence from multiple computer systems according to some aspects of the present disclosure.

FIG. 2 shows a block diagram of another example of a computing environment for integrating evidence from multiple computer systems and providing the evidence to users for satisfying standards according to some aspects of the present disclosure.

FIG. 3 shows a flowchart of an example of a process for integrating evidence from multiple computer systems and providing the to the evidence to users for satisfying standards according to some aspects of the present disclosure.

FIG. 4 depicts a block diagram of an example of a computing device usable to implement some aspects of the present disclosure.

### DETAILED DESCRIPTION

Certain aspects and features of the present disclosure relate to an integration system for integrating evidence from multiple computer systems in a computing environment to facilitate automatic transmission of the evidence based on requirements of standards. The computing environment may be a distributed computing environment, such as a cloud computing environment, cluster, or data grid. The computing environment can include any number and combination of nodes (e.g., physical or virtual servers, client devices, etc.) that can execute software. Each of the nodes can store and/or manage different types of evidence (e.g., data records, log data, files, images, etc.). The integration system can communicate with the computer systems (e.g., the nodes) to obtain pieces of evidence, index them, map them, and store them in a repository.

In some examples, the integration system can generate a mapping table that relates each of the pieces of evidence in the repository with one or more of the standards. To do so, the integration system can detect a set of requirements for each standard, determine which pieces of evidence correspond to each standard based on the set of requirements, and construct the mapping table accordingly. The sets of requirements can define actions the entity must perform to meet the standards. The sets of requirements can also define types or amounts of evidence required for the standards or for demonstrating an action is being performed. Thus, each piece of evidence can be related with one or more standards based on the piece of evidence being usable to satisfy a requirement of that standard.

Additionally, in some examples, the integration system can receive requests for evidence for standards from user devices. In response, the integration system may analyze the mapping table to identify pieces of evidence that are stored in the repository and related with the standards. The integration system may then automatically obtain the pieces of evidence from the repository and transmit the pieces of evidence to the user devices in response to the requests. Thus, the integration system can provide evidence to users in an efficient manner without requiring multiple requests to multiple computer systems. Additionally, the integration system can transmit evidence to user devices on behalf of the computer systems, thereby reducing latency for the computer systems.

Furthermore, in some examples, the integration system can update the mapping table over time. For example, the integration system can detect additional standards or modifications to the standards. A modification to a standard may include a requirement being added to or removed from the standard, or a requirement being revised. In response to detecting a modification to a standard, the integration system may update the mapping table to relate a piece of evidence associated with the added requirement to the standard or to unrelate a piece of evidence associated with the removed requirement from the standard. Additionally, the integration system may update the mapping table to relate different evidence the standard based on the revised requirement. By detecting additional standards or modifications to standards and updating the mapping table accordingly, the integration system can accurately and efficiently transmit evidence for standards to user devices.

As noted earlier, evidence for use in satisfying regulatory requirements may normally be managed by various disparate computer systems in a computing environment. Users may operate client devices to communicate with the computer systems to request such evidence as needed. Each of the computer systems can receive such evidence requests and transmit the requested pieces of evidence back to the client devices. But this can be a slow and inefficient process (e.g., if many pieces of evidence are needed from many computer systems). For the users, having to submit individual requests for evidence to several disparate computer systems is slow and tedious. And for the computer systems, handling such evidence requests can disrupt operations and increase latency. For example, requesting a piece of evidence from a software application or service may disrupt one or more tasks already being performed by the software application or service. Handling these requests also consumes the bandwidth, processing power, and memory of the computer systems. And if a piece of evidence is requested by more than one user, the computer system managing the piece of evidence may have to repeatedly locate and transmit the piece of evidence multiple times, which may further increase bandwidth consumption and latency in the computer system. Thus, there is a need for a more efficient way of managing and transmitting such evidence to client devices in a computer network.

Some examples of the present disclosure can overcome one or more of the abovementioned problems by providing an integration system that can selectively and automatically obtain, reformat, map, store, and integrate evidence from various computer systems of a computing environment. The integration system can also act as a centralized handler for evidence requests and, in some examples, can handle bulk requests for evidence from a user in an efficient and timely manner, so that the user need not issue multiple individual evidence requests to different computer systems. Through this functionality, the integration system can reduce the number of times each of the other computer systems must be accessed to obtain evidence and respond to evidence requests, thereby reducing bandwidth consumption and the load on those computer systems. This, in turn, can allow the computer systems to perform their other tasks with reduced latency and improved responsiveness, thereby improving the functionality of the computing environment as a whole.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

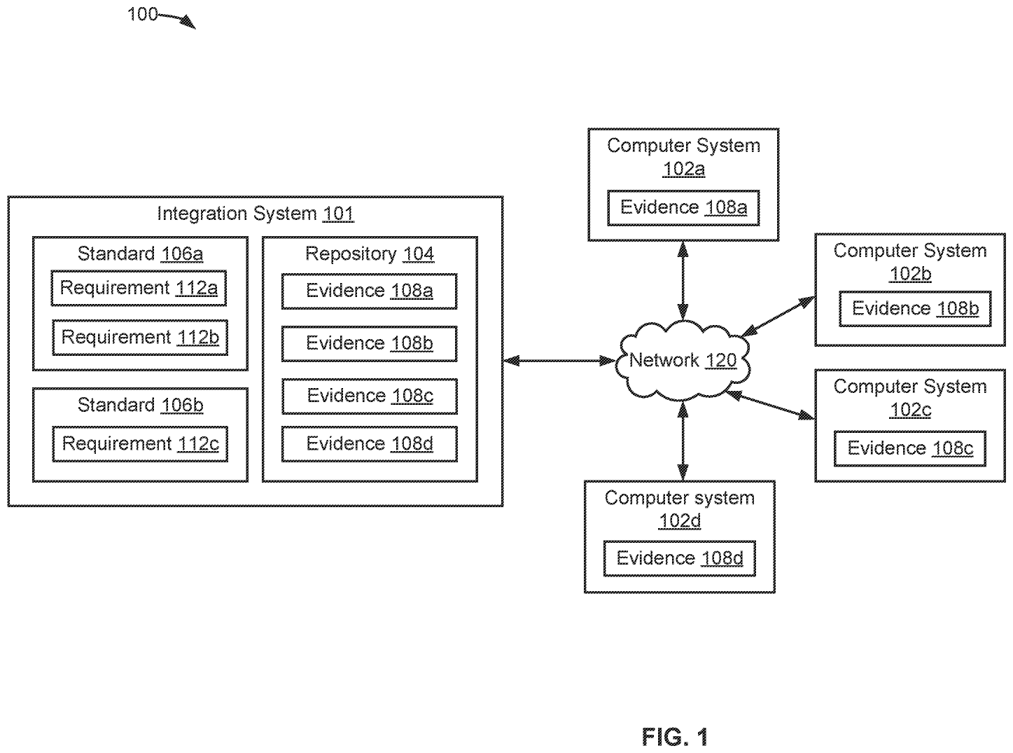

FIG. 1 shows a block diagram of an example of a computing environment 100 for integrating evidence from multiple computer systems 102a-d according to some aspects of the present disclosure. The computing environment 100 can be a distributed computing environment, such as a cloud computing environment or the like.

The computing environment 100 can also include computer systems 102a-d, which can be communicatively coupled with the integration system 101 and one another via a network 120 such as a local area network (LAN) or the internet. The computer systems 102a-d can each include one or more nodes on which software (e.g., applications, services, or the like) may be executing. Each of the nodes can store and manage different types of evidence, in addition to performing other tasks.

In some examples, an entity (e.g., a financial institution or a division within the financial institution) can be required to meet standards, such as a first standard 106a and a second standard 106b. The first standard 106a can include requirements 112a-b and the second standard 106b can include requirement 112c. The requirements 112a-c can define actions the entity must perform to abide by or otherwise meet the standards 106a-b. For an example which the entity is a financial institution, types of standards may include capital adequacy standards, liquidity standards, risk management standards, consumer protection standards, cybersecurity standards, etc. Requirements for the standards may include the entity implementing particular security protocols, risk management protocols, or performing other suitable tasks. Additionally, the requirements for the standards may include the entity maintaining particular amounts or types of data.

Pieces of evidence 108a-d can demonstrate that each of the requirements 112a-c of each of the standards 106a-b is being met. The pieces of evidence 108a-d may include data records, files, log data, images, or other suitable data. The pieces of evidence 108a-d may be stored and managed by each of the computer systems 102a-d. For example, a first piece of evidence 108a can be stored and managed by a first computer system 102a, a second piece of evidence 108b can be stored and managed by a second computer system 102b, a third piece of evidence 108c can be stored and managed by a third computer system 102c, and a fourth piece of evidence 108d can be stored in and managed by a fourth computer system 102d.

A user may be able to confirm whether one or more of the standards 106a-b are satisfied using the evidence 108a-d. However, for security and other reasons, the user may not be provided direct access to the evidence. Rather, the user may need to request the evidence from some or all of the computer systems 102a-d, which may implement access controls and other security measures. To that end, the user may transmit requests for each of the pieces of evidence 108a-d to each of the computer systems 102a-d. But, transmitting requests to each of the computer systems can be time-consuming and tedious. Handling each individual evidence request also consumes the computing resources (e.g., processing power, memory, and bandwidth) of the computer systems 102a-d. Additionally, if a piece of evidence is required by more than one user, a computer system managing the piece of evidence may have to obtain and transmit the piece of evidence multiple times, which further consumes computing resources and may cause latency for the computing environment 100.

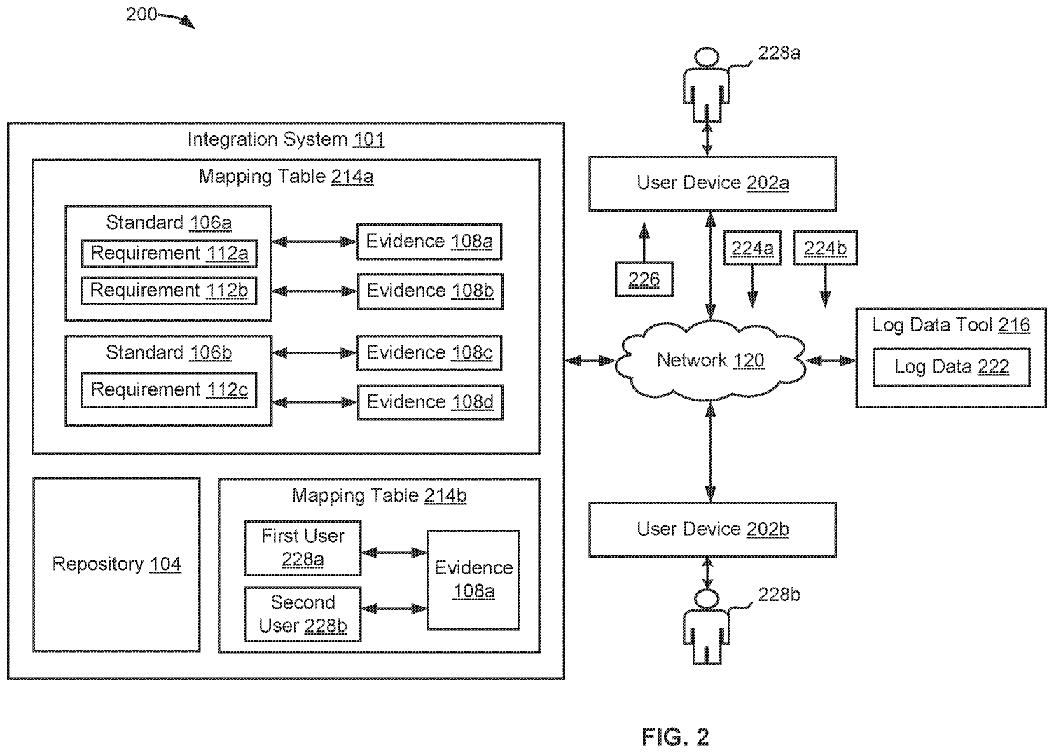

Thus, to reduce resource consumption in and improve the efficiency of the computing environment 100, some examples can include an integration system 101. The integration system 101 can be configured to obtain evidence from multiple sources, index the evidence, reformat the evidence, integrate the evidence, and provide the evidence to the users. In particular, the integration system 101 can obtain and integrate the pieces of evidence 108a-d from the computer systems 102a-d. In some examples, the integration system 101 may request each of the pieces of evidence 108a-b from each of the computer systems 102a-d. Additionally or alternatively, the computer systems 102a-d may automatically transmit the pieces of evidence 108a-d to the integration system 101. Either way, the integration system 101 may receive evidence from the computer systems 102a-d periodically (e.g., every six months) to facilitate transmission of accurate and up-to-date evidence by the integration system 101. The integration system may then store the pieces of evidence 108a-d in a repository 104. The integration system 101 can further use the acquired evidence to respond to evidence requests from the user devices, freeing up the computer systems 102a-d for other tasks. Further details are described with respect to FIG. 2 below.

FIG. 2 shows a block diagram of another example of a computing environment 200 for integrating evidence from multiple computer systems and providing the evidence to users 228a-b for satisfying standards according to some aspects of the present disclosure. More specifically, the computing environment 200 can include an integration system 101 for obtaining evidence from multiple sources (e.g., computer systems 102a-d depicted in FIG. 1), integrating the evidence, and providing the evidence to the users 228a-b. The integration system 101 may provide the evidence to the users 228a-b by, for example, transmitting the evidence to one or both of user devices 202a-b. Examples of the user devices 202a-b can include a laptop computer, desktop computer, mobile telephone, e-reader, server, or tablet. The user devices 202a-b can be external to the integration system 101 and communicatively coupled to the integration system 101 via a network 120, such as a local area network (LAN) or the Internet.

In some examples, the users 228a-b can be associated with an entity (e.g., a financial institution or a division within the financial institution). The entity can be required to meet standards, such as a first standard 106a and a second standard 106b. The standards 106a-b can each include requirements 112a-c, which can define actions the entity must perform to abide by or otherwise meet the standards 106a-b. In a particular example, the first standard 106a can be a cyber security standard. A first requirement 112a of the first standard 106a can involve the entity performing an annual security audit and a second requirement 112b of the first standard 106a can involve the entity implementing a cybersecurity policy. Additionally, the second standard 106b can be a risk management standard. A requirement 112c of the second standard 106b can involve the entity performing a risk assessment.

To satisfy the standards 106a-b, the users 228a-b may obtain pieces of evidence 108a-d which prove that each requirement of each standard is being met by the entity. The pieces of evidence 108a-d may include data records, files, log data, images, or other suitable data. In the particular example, a first piece of evidence 108a for the first requirement 112a can be one or more files associated with the annual security audit. Similarly, a second piece of evidence 108b for the second requirement 112b can be one or more files associated with the cybersecurity policy. Additionally, in some examples, more than one piece of evidence can be necessary to meet a requirement of a standard. Thus, in the particular example, a third piece of evidence 108c can be log data 222 associated with performing the risk assessment and a fourth piece of evidence 108d can be a data record corresponding to results of the risk assessment.

As discussed above with respect to FIG. 1, the pieces of evidence 108a-d may be stored and managed by various computer systems 102a-d associated with the entity. In the particular example, the one or more files associated with the annual security audit can be stored in a first computer system 102a, the one or more files associated with the cybersecurity policy can be stored in a second computer system 102b, the log data 222 can be stored and managed by a third computer system 102c, and the data record for the risk assessment can be stored in a fourth computer system 102d. The integration system 101 can obtain and integrate the pieces of evidence 108a-d from the computer systems 102a-d. For example, the integration system 101 may request each of the pieces of evidence 108a-b from each of the computer systems 102a-d. Additionally or alternatively, the computer systems 102a-d may automatically transmit the pieces of evidence 108a-d to the integration system 101.

As one example of how data is acquired by the integration system 101, in some examples a log data tool 216 can manage and store the log data 222. The log data tool 216 may be executing on the third computer system 102c or can otherwise be communicatively coupled with the user devices 202a-b and the integration system 101 via the network 120. The log data tool 216 can collect the log data 222 over time, for example to log application events, network security events, or other events in the computing environment 200. The log data tool 216 may obtain the log data 222 from an application associated with the entity, from a log repository, or from another suitable location. The log data tool 216 can then transmit the log data 222 to the integration system 101, which can store the log data 222 for subsequent use in handling evidence requests related to the log data 222.

In some examples, the integration system 101 may store the pieces of evidence 108a-d (e.g., the files, log data 222, and data record) in a repository 104. The integration system 101 can further generate a mapping table 214a to relate each of the pieces of evidence 108a-d stored in the repository 104 to with one or more of the standards 106a-b. To do so, the integration system 101 may detect which of the standards 106a-b can be satisfied by each of the pieces of evidence 108a-d based the requirements 112a-c. For example, the integration system 101 may determine that the first requirement 112a and the first piece of evidence 108a are related to the annual security audit. Similarly, the integration system 101 may determine that the second requirement 112b and the second piece of evidence 108b are related to the cyber security policy. Additionally, the first requirement 112a may include an indication that files for the annual security audit should be used as evidence and the second requirement 112b may include an indication that files for the cyber security policy should be used as evidence. Thus, as depicted in FIG. 1, the first piece of evidence 108a and the second piece of evidence 108b can be mapped to the first standard 106a based on the first requirement 112a and the second requirement 112b. Additionally, the integration system 101 can determine that the third piece of evidence 108c, the fourth piece of evidence 108d, and the third requirement 112c are related to the risk assessment. Additionally, the third requirement 112c can indicate that log data for performing the risk assessment and a data record of results of the risk assessment should be used as evidence. Thus, the third piece of evidence 108c and the fourth piece of evidence 108d can be mapped to the second standard 106b based on the third requirement 112c.

In some examples, the integration system 101 can update the mapping table 214a over time. For example, the integration system 101 may detect a modification to the first standard 106a. The integration system 101 may detect the modification by receiving an indication of the modification from one or both of the user devices 202a-d. The modification may involve adding a requirement to the first standard 106a, modifying the first requirement 112a, removing a prior requirement for the first standard 106a, or otherwise altering the requirements for satisfying the first standard 112a. As a result of the modification, a type of evidence or an amount of evidence required for satisfying the first standard 106a may change. Therefore, in response to the modification to the first standard 106a, the integration system 101 can update the mapping table 114a. For example, if the first standard 106a is modified to include a new requirement and the repository 104 includes an additional piece of evidence associated with the new requirement, the integration system 101 can update the mapping table 214a to relate the additional piece of evidence with the first standard 106a.

The integration system 101 can also serve as a centralized location for handling evidence requests from the user devices 202a-b. For example, a user 228a can transmit a request 224a for evidence for the first standard 106a via the user device 202a. In response to the request 224a, the integration system 101 may access the mapping table 214a to identify which of the pieces of evidence 108a-d stored in the repository 104 is associated with the first standard 106a. Thus, the integration system 101 can identify, using the mapping table 214a, that the first piece of evidence 108a and the second piece of evidence 108b are associated with the first standard 106a. As a result, the integration system 101 can obtain the pieces of evidence 108a-b from the repository 104. The integration system 101 can then transmit the pieces of evidence 108a-b to the user device 202a as a response 226 to the request 224a.

In this way, the integration system 101 can automatically determine which pieces of evidence are required to satisfy a standard, obtain some or all of those pieces of evidence, and return them to the requestor, in one bulk action. This can prevent against the user having to issue multiple separate requests for each piece of evidence to the separate computer systems, which can normally be time consuming and tedious, as well as consume the bandwidth and resources of the computer systems.

The integration system 101 may further generate mapping table 214b that correlates evidence to users. The integration system 101 may generate the mapping table 214b based on historical data indicating pieces of evidence previously requested by users, and/or based on any other suitable data which correlates pieces of evidence with one or more users. In an example, a first user 228a and a second user 228b may have previously requested data similar to the first piece of evidence 108a (e.g., a previous annual security audit). Thus, the mapping table 214b may relate the users 228a-b to the first piece of evidence 108a. Due to the mapping table 214b relating the users 228a-b with the first piece of evidence 108a, the integration system 101 may automatically transmit at least the first piece of evidence 108a to a second user device 202b associated with the second user 228b in response to the request 224a from the user device 202a. In this way, the integration system 101 can minimize repetitive requests for the same pieces of evidence to reduce latency for the integration system 101 and to provide the pieces of evidence to users in an efficient and convenient manner (e.g., without requiring a request).

In another example, the integration system 101 may receive a request 224b from the user device 202a for evidence associated with a third standard. The integration system 101 may determine, based on the mapping table 214a, that the third standard is excluded from the standards 106a-b. In response, the integration system 101 may then determine (e.g., receive) the requirements included in the third standard. For example, the requirements for the third standard may be included in the request 224b or stored in a predefined file, which can be used to determine the requirements. The integration system 101 can then determine whether the requirements of the third standard match any requirements of the standards 106a-b. As a result, the integration system 101 may, for example, determine that a requirement 112c of the second standard 106b matches a requirement of the third standard. In response, the integration system 101 can identify the third piece of evidence 108c and the fourth piece of evidence 108a using the mapping table 214a. The integration system 101 can then obtain the pieces of evidence 108c-d from the repository 104 and can transmit the pieces of evidence 108c-d as a response to the request 224b. Additionally, the integration system 101 may update the mapping table 214a to include the third standard and to relate the third piece of evidence 108c and the fourth piece of evidence 108d to the third standard.

Additionally or alternatively, the integration system 101 may detect that at least some of the requirements of the third standard do not match the requirements 112a-c of the first and second standards 106a-b. In response, the integration system 101 can transmit an indication that the repository 104 does not include all or some of the evidence for the third standard to the user device 202a. The integration system 101 may also request evidence for satisfying the third standard from one or more computer systems on behalf of the user device 202a. Then, after receiving the evidence for the third standard, the integration system 101 may transmit the evidence to the user device 202a and may store the evidence in the repository 104. The integration system 101 may also update the mapping table 214a to include the third standard and to relate the third standard with the evidence. In this way, the integration system 101 can provide evidence to users for previously unknown standards. Additionally, the integration system 101 can continuously update the repository 104, the mapping table 214a, or a combination thereof to include previously unknown standards.

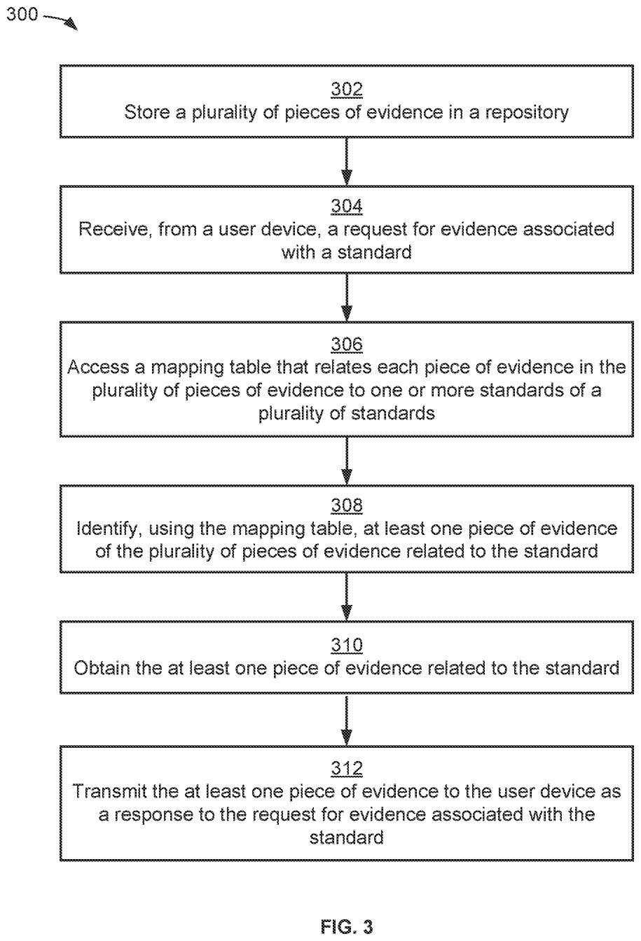

FIG. 3 shows a flowchart of an example of a process 300 for integrating evidence from multiple sources (e.g., computer systems) and providing the evidence to users for satisfying standards according to some aspects of the present disclosure. Other examples may involve more operations, fewer operations, different operations, or a different order of the operations than is shown in FIG. 3. The operations of FIG. 3 are described below with reference to the components of FIGS. 1-2 above.

In block 302, the integration system 101 can store a plurality of pieces of evidence 108a-d in a repository 104. The integration system 101 may store the pieces of evidence 108a-b after receiving the pieces of evidence 108a-d from one or more computer systems. For example, the integration system 101 may receive a list or other suitable indication of standards 106a-b. The integration system 101 may use the list or other suitable indication of the standards 106a-b to determine the pieces of evidence 108a-d required for the standards 106a-b. Then, the integration system 101 can transmit requests for the pieces of evidence 108a-d to the computer systems.

In block 304, the integration system 101 can receive, from a user device 202a, a request 224a for evidence associated with a standard 106b. For example, the request 224a may be received from the user device 202a associated with a user 228a. The standard 106b can be a risk management standard or another suitable standard imposed on an entity associated with the user 228a. For example, the entity may be a financial institution and the user 228a may be an employee of the financial institution.

In block 306, the integration system 101 can access a mapping table 214a that relates each piece of evidence of the plurality of pieces of evidence 108a-d to one or more standards of a plurality of standards 106a-b. The mapping table 214a can relate each piece of evidence to the one or more standards based on each piece of evidence satisfying a requirement of the one or more standards. For example, the mapping table 214a can relate each of the pieces of evidence 108a-d to one or both of the standards 106a-b. As depicted in FIG. 2, a first piece of evidence 108a and a second piece of evidence 108b can be related in the mapping table 214a to a first standard 106a. Additionally, a third piece of evidence 108c and a fourth piece of evidence 108d can be related in the mapping table 214a to a second standard 106b.

In block 308, the integration system 101 can identify, using the mapping table 214a, at least one piece of evidence of the plurality of pieces of evidence 108a-d related to the standard 106b. The integration system 101 can then determine whether any of the identified pieces of evidence can be obtained from the repository 104. In the example, the integration system 101 can identify that two pieces of evidence 108c-d are stored in the repository 104 and associated with the second standard 106b based on the mapping table 214a.

In block 310, the integration system 101 can obtain the at least one piece of evidence from the repository 104 and transmit the at least one piece of evidence to the user device 202a as a response 226 to the request 224a for evidence associated with the standard 106b. In the example, in response to identifying the pieces of evidence 108c-d, the integration system 101 can obtain the pieces of evidence 108c-d from the repository 104. The integration system 101 can then transmit the pieces of evidence 108c-d to the user device 202a as a response 226 to the request 224a. The user 228a of the user device 202a can then use the evidence 108c-d to satisfy the standard 106b.

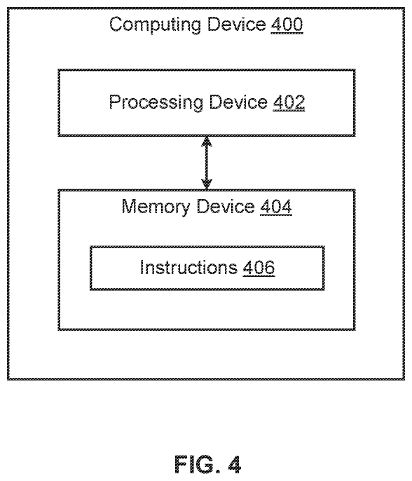

FIG. 4 depicts a block diagram of an example of a computing device 400 usable to implement some aspects of the present disclosure. For example, the computing device 400 can serve as the integration system 101 of FIG. 1.

The computing device 400 includes a processing device 402 coupled to a memory device 404 via a bus. The processing device 402 can include one processing device or multiple processing devices. Non-limiting examples of the processing device 402 include a Field-Programmable Gate Array (FPGA), an application-specific integrated circuit (ASIC), a microprocessor, or any combination of these. The processing device 402 can execute instructions 406 stored in the memory device 404 to perform operations. Examples of such operations can include any of the operations described above with respect to the integration system 101. In some examples, the instructions 406 can include processor-specific instructions generated by a compiler or an interpreter from code written in any suitable computer-programming language, such as C, C++, C#, Python, or Java.

The memory device 404 can include one memory device or multiple memory devices. The memory device 404 can be volatile or non-volatile, such that the memory device 404 retains stored information when powered off. Non-limiting examples of the memory device 404 include electrically erasable and programmable read-only memory (EEPROM), flash memory, or any other type of non-volatile memory. At least some of the memory device can include a non-transitory computer-readable medium from which the processing device 402 can read instructions 406. A computer-readable medium can include electronic, optical, magnetic, or other storage devices capable of providing the processing device 402 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 406.

The computing device 400 may also include other input and output (I/O) components, which are not shown here for simplicity. The input components can include a mouse, a keyboard, a trackball, a touch pad, a touch-screen display, or any combination of these. The output components can include a visual display, an audio display, a haptic display, or any combination of these. Examples of a visual display can include a liquid crystal display (LCD), a light-emitting diode (LED) display, and a touch-screen display. An example of an audio display can include speakers. Examples of a haptic display may include a piezoelectric device or an eccentric rotating mass (ERM) device.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to perform operations comprising:
storing a plurality of pieces of evidence in a repository;
subsequent to storing the plurality of pieces of evidence in the repository, receiving, from a user device, a request for evidence associated with a standard;
in response to receiving the request, accessing a mapping table that relates each piece of evidence of the plurality of pieces of evidence to one or more standards of a plurality of standards, wherein the mapping table relates each piece of evidence of the plurality of pieces of evidence to the one or more standards of the plurality of standards based on each piece of evidence satisfying a requirement of the one or more standards;
identifying, using the mapping table, at least one piece of evidence of the plurality of pieces of evidence related to the standard;
in response to identifying the at least one piece of evidence of the plurality of pieces of evidence related to the standard, obtaining the at least one piece of evidence from the repository and transmitting the at least one piece of evidence to the user device as a response to the request for the evidence associated with the standard.

2. The system of claim 1, wherein the memory device further includes instructions executable by the processing device for causing the processing device to perform operations comprising:
for each standard of the plurality of standards:
determining at least one piece of evidence required to satisfy the standard; and
configuring the mapping table to correlate the at least one piece of evidence to the standard.

3. The system of claim 1, wherein the request is a first request, the evidence is first evidence, the standard is a first standard, and the user device is a first user device, and wherein the memory device further includes instructions executable by the processing device for causing the processing device to perform operations comprising:
receiving, from a second user device, a second request for second evidence associated with a second standard;
determining, based on the mapping table, that the second standard is excluded the plurality of standards;
in response to determining that the second standard is excluded from the plurality of standards:
determining a requirement of the second standard;
determining that a third standard of the plurality of standards also involves the requirement;
determining, based on the mapping table, that a piece of evidence of the plurality of pieces of evidence is correlated to the third standard and usable to satisfy the requirement;
in response to determining that the piece of evidence is correlated to the third standard and usable to satisfy the requirement, obtaining the piece of evidence from the repository and transmitting the piece of evidence to the second user device as a response to the second request.

4. The system of claim 1, wherein the plurality of pieces of evidence comprises log data, data records, and files, the log data being receivable from a log data tool executing on at least one user device.

5. The system of claim 1, wherein the user device is associated with a first user, and wherein the memory device further includes instructions executable by the processing device for causing the processing device to perform operations comprising:
in response to receiving the request from the user device:
accessing a second mapping table that correlates evidence to users, wherein the at least one piece of evidence is correlated to a second user in the mapping table;
determining, based on the second mapping table, that the at least one piece of evidence is correlated with the second user; and
based on determining that the at least one piece of evidence is correlated with the second user in the second mapping table, automatically providing the at least one piece of evidence to a second user device of the second user.

6. The system of claim 5, wherein the first user is part of a first set of users associated with a first standard of the plurality of standards, and wherein the second user is part of a second set of users associated with a second standard of the plurality of standards, the second standard being different from the first standard.

7. The system of claim 1, wherein the memory device further includes instructions executable by the processing device for causing the processing device to perform operations comprising:
detecting a modification to at least one requirement of the standard, wherein the modification to the at least one requirement changes the at least one piece of evidence of the plurality of pieces of evidence that is usable to satisfy the at least one requirement of the standard; and
updating the mapping table based on the modification to the at least one requirement.

8. A computer-implemented method comprising:
storing a plurality of pieces of evidence in a repository;
subsequent to storing the plurality of pieces of evidence in the repository, receiving, from a user device, a request for evidence associated with a standard;
in response to receiving the request, accessing a mapping table that relates each piece of evidence of the plurality of pieces of evidence to one or more standards of a plurality of standards, wherein the mapping table relates each piece of evidence of the plurality of pieces of evidence to the one or more standards of the plurality of standards based on each piece of evidence satisfying a requirement of the one or more standards;
identifying, using the mapping table, at least one piece of evidence of the plurality of pieces of evidence related to the standard;
in response to identifying the at least one piece of evidence of the plurality of pieces of evidence related to the standard, obtaining the at least one piece of evidence from the repository and transmitting the at least one piece of evidence to the user device as a response to the request for the evidence associated with the standard.

9. The computer-implemented method of claim 8, further comprising:
for each standard of the plurality of standards:
determining at least one piece of evidence required to satisfy the standard; and
configuring the mapping table to correlate the at least one piece of evidence to the standard.

10. The computer-implemented method of claim 8, wherein the request is a first request, the evidence is first evidence, the standard is a first standard, and the user device is a first user device, and wherein the computer-implemented method further comprises:
receiving, from a second user device, a second request for second evidence associated with a second standard;
determining, based on the mapping table, that the second standard is excluded the plurality of standards;
in response to determining that the second standard is excluded from the plurality of standards:
determining a requirement of the second standard;
determining that a third standard of the plurality of standards also involves the requirement;
determining, based on the mapping table, that a piece of evidence of the plurality of pieces of evidence is correlated to the third standard and usable to satisfy the requirement;
in response to determining that the piece of evidence is correlated to the third standard and usable to satisfy the requirement, obtaining the piece of evidence from the repository and transmitting the piece of evidence to the second user device as a response to the second request.

11. The computer-implemented method of claim 8, wherein the plurality of pieces of evidence comprises log data, data records, and files, the log data being receivable from a log data tool executing on at least one user device.

12. The computer-implemented method of claim 8, wherein the user device is associated with a first user, and wherein the computer-implemented method further comprises:
in response to receiving the request from the user device:
accessing a second mapping table that correlates evidence to users, wherein the at least one piece of evidence is correlated to a second user in the mapping table;
determining, based on the second mapping table, that the at least one piece of evidence is correlated with the second user; and
based on determining that the at least one piece of evidence is correlated with the second user in the second mapping table, automatically providing the at least one piece of evidence to a second user device of the second user.

13. The computer-implemented method of claim 12, wherein the first user is part of a first set of users associated with a first standard of the plurality of standards, and wherein the second user is part of a second set of users associated with a second standard of the plurality of standards, the second standard being different from the first standard.

14. The computer-implemented method of claim 8, further comprising:
detecting a modification to at least one requirement of the standard, wherein the modification to the at least one requirement changes the at least one piece of evidence of the plurality of pieces of evidence that is usable to satisfy the at least one requirement of the standard; and
updating the mapping table based on the modification to the at least one requirement.

15. A non-transitory computer-readable medium comprising instructions that are executable by a processing device for causing the processing device to perform operations comprising:
storing a plurality of pieces of evidence in a repository;
subsequent to storing the plurality of pieces of evidence in the repository, receiving, from a user device, a request for evidence associated with a standard;
in response to receiving the request, accessing a mapping table that relates each piece of evidence of the plurality of pieces of evidence to one or more standards of a plurality of standards, wherein the mapping table relates each piece of evidence of the plurality of pieces of evidence to the one or more standards of the plurality of standards based on each piece of evidence satisfying a requirement of the one or more standards;
identifying, using the mapping table, at least one piece of evidence of the plurality of pieces of evidence related to the standard;
in response to identifying the at least one piece of evidence of the plurality of pieces of evidence related to the standard, obtaining the at least one piece of evidence from the repository and transmitting the at least one piece of evidence to the user device as a response to the request for the evidence associated with the standard.

16. The non-transitory computer-readable medium of claim 15, further comprising instructions executable by the processing device for causing the processing device to perform operations comprising:
for each standard of the plurality of standards:
determining at least one piece of evidence required to satisfy the standard; and
configuring the mapping table to correlate the at least one piece of evidence to the standard.

17. The non-transitory computer-readable medium of claim 15, wherein the request is a first request, the evidence is first evidence, the standard is a first standard, and the user device is a first user device, and further comprising instructions executable by the processing device for causing the processing device to perform operations comprising:
receiving, from a second user device, a second request for second evidence associated with a second standard;
determining, based on the mapping table, that the second standard is excluded the plurality of standards;
in response to determining that the second standard is excluded from the plurality of standards:
determining a requirement of the second standard;
determining that a third standard of the plurality of standards also involves the requirement;
determining, based on the mapping table, that a piece of evidence of the plurality of pieces of evidence is correlated to the third standard and usable to satisfy the requirement;
in response to determining that the piece of evidence is correlated to the third standard and usable to satisfy the requirement, obtaining the piece of evidence from the repository and transmitting the piece of evidence to the second user device as a response to the second request.

18. The non-transitory computer-readable medium of claim 15, wherein the plurality of pieces of evidence comprises log data, data records, and files, the log data being receivable from a log data tool executing on at least one user device.

19. The non-transitory computer-readable medium of claim 15, wherein the user device is associated with a first user, and further comprising instructions executable by the processing device for causing the processing device to perform operations comprising:
in response to receiving the request from the user device:
accessing a second mapping table that correlates evidence to users, wherein the at least one piece of evidence is correlated to a second user in the mapping table;
determining, based on the second mapping table, that the at least one piece of evidence is correlated with the second user; and
based on determining that the at least one piece of evidence is correlated with the second user in the second mapping table, automatically providing the at least one piece of evidence to a second user device of the second user.

20. The non-transitory computer-readable medium of claim 19, wherein the first user is part of a first set of users associated with a first standard of the plurality of standards, and wherein the second user is part of a second set of users associated with a second standard of the plurality of standards, the second standard being different from the first standard.
